(19) United States
(12) Patent Application Publication
(10) Pub. No.: US 2025/0282635 A1
(43) Pub. Date: Sep. 11, 2025

(54) MULTIFUNCTIONAL WATER-BASED COATING AND PREPARATION METHOD THEREFOR AND USE THEREOF

(71) Applicants: Haimen Power Plant of Huaneng (Guangdong) Energy Development Co., Ltd., Shantou City (CN); Shantou University, Shantou City (CN)

(72) Inventors: Shuangxi Wang, Shantou City (CN); Weipeng Sun, Shantou City (CN); Tingyou Feng, Shantou City (CN); Yang Lyu, Shantou City (CN); Chuwei Lin, Shantou City (CN); Yong Jiang, Shantou City (CN)

(73) Assignees: Haimen Power Plant of Huaneng (Guangdong) Energy Development Co., Ltd., Shantou City (CN); Shantou University, Shantou City (CN)

(21) Appl. No.: 19/215,088

(22) Filed: May 21, 2025

(30) Foreign Application Priority Data
May 22, 2024 (CN) 202410635306.8

(51) Int. Cl. C01G 3/02; C08K 3/34; C08K 7/00; C08K 9/02; C08K 9/06; C09D 5/02; C09D 5/08; C09D 5/16; C09D 7/62; C09D 7/80; C09D 133/04

(52) U.S. Cl. CPC C01G 3/02; C08K 3/34; C08K 7/00; C08K 9/02; C08K 9/06; C09D 5/024; C09D 5/08; C09D 5/1687; C09D 7/62; C09D 7/80; C09D 133/04; C01P 2004/03; C08K 2201/011

(57) ABSTRACT

The disclosure relates to a multifunctional water-based coating and its preparation method. The coating consists of a surface-grafted flower-ball-shaped nano cuprous oxide, nano lithium silicate, a water-based acrylic emulsion, a wetting agent, a defoaming agent and a dispersing agent. The flower-ball-shaped nano cuprous oxide is etched by introducing a bacterial liquid and is subjected to surface modification by using a silane coupling agent, titanium dioxide, silicon dioxide, etc., so as to improve the performances of the coating layer such as fouling resistance, strength, dispersibility, ageing resistance and insolation resistance. The coating of the disclosure has multiple functions, a wide application range and a long service life, and can be used for surface protection of marine facilities, coastal buildings and coastal steel structures. The materials used are cheap and easy to obtain, have no pollution to the environment, and are suitable for large-scale production.

### CROSS-REFERENCE TO RELATED APPLICATIONS

This application claims priority of Chinese Patent Application No. 202410635306.8, filed on May 22, 2024, the contents of which are hereby incorporated by reference.

### TECHNICAL FIELD

The disclosure belongs to the technical field of coating preparation, and specifically relates to a multifunctional water-based coating and a preparation method therefor and use thereof.

### BACKGROUND

Corrosion, rusting and marine microbial fouling have a serious impact on the normal operation and operational performances of marine equipment. Marine organisms such as various bacteria, shellfish and algae live in the sea and may damage surface corrosion-resistant coating layers of marine equipment, thereby accelerating the corrosion rate of the marine equipment. In addition, secretions from marine animals may also corrode or damage the surface corrosion-resistant coating layers of the marine equipment, thereby reducing performances and shortening service life.

The existing commercially available coatings have relatively single function: the corrosion-resistant coatings cannot resist fouling, and the fouling-resistant coatings have poor ageing resistance and insolation resistance, and short service life. Cuprous oxide particles are added into some coatings as an antifouling agent. However, since the bonding strength of the inorganic material cuprous oxide and the organic resin is low, the cuprous oxide particles in the cured coating layers are easy to fall off under the washing of seawater or rainwater. For example, patent CN102807774A discloses “Surface Modification Method For Cuprous Oxide Antifouling Agent”: chitosan-Arabic gum is used to prepare a chitosan-Arabic gum cuprous oxide microcapsule powder, and the powder is added into an antifouling coating as an antifouling agent; since the surfaces of the cuprous oxide particles are smooth, the bonding strength between cuprous oxide and the coating layer is low, so the service life of the coating is no more than one year. Patent CN116285465A discloses “High-Stability Cuprous Oxide Composite Antifouling Agent Material and Preparation Method Therefor”: a phenolic hydroxyl group-rich material is encapsulated onto an outer surface of a cuprous oxide micro-nano particle to form a reductive organic layer, thereby significantly improving the stability of the cuprous oxide antifouling agent. Patent CN111440499A discloses “Water-Based Antifouling Coating and Preparation Method Therefor”: polyhedral oligomeric silsesquioxane is used as a carrier to make cuprous oxide bound in a cylindrical cage structure, so as to improve the stability of cuprous oxide, but the coating layer is also difficult to maintain the lasting stability for more than one year under the continuous erosion of seawater silt.

Therefore, the development of a multifunctional coating with both corrosion resistance and fouling resistance, particularly a coating whose coating layer has stronger strength, erosion resistance, ageing resistance and insolation resistance, is very important for developing and utilizing marine resources.

### SUMMARY

The disclosure aims to provide a multifunctional water-based coating and a preparation method therefor and use thereof, so as to solve the problems that the existing coatings have relatively single function: the corrosion-resistant coatings cannot resist fouling; and the fouling-resistant coatings have poor ageing resistance and insolation resistance, and short service life.

A method for preparing a surface-grafted flower-ball-shaped nano cuprous oxide coated with a titanium-silicon film includes the following steps:
(1) preparing flower-ball-shaped nano cuprous oxide;
(2) stirring and mixing the flower-ball-shaped nano cuprous oxide, tetraethyl titanate and tetraethyl orthosilicate at a mass ratio of (3-5):(2-4):(5-10), and forming a titanium-silicon film on the surface of the flower-ball-shaped nano cuprous oxide;
(3) mixing the flower-ball-shaped nano cuprous oxide particle with a titanium-silicon film obtained in step (2) with absolute ethanol at a mass ratio of (1-3):5; and
(4) adjusting the pH value of the solution to 5, then adding a silane coupling agent (preferably KH570), and stirring in a water bath at 50-60° C. for 2-4 h to obtain the surface-grafted flower-ball-shaped nano cuprous oxide coated with a titanium-silicon film.

Further, the preparation of the flower-ball-shaped nano cuprous oxide includes: transferring cuprous oxide nanoparticles into a tryptic soy broth, then adding a Bacillus bacterial liquid, and culturing for 48-72 h in an orbital rotary shaker at 25-30° C.; and after the culture is finished, centrifuging and washing the reaction mixture, and collecting and drying the precipitate to obtain flower-ball-shaped nano cuprous oxide.

Further, the mass ratio of the cuprous oxide nanoparticles to the Bacillus bacterial liquid is (3-5): 1.

Further, the mass ratio of the cuprous oxide nanoparticles to the bacterial liquid is (3-5): 1. The ratio of the cuprous oxide nanoparticles to the Bacillus bacterial liquid determines the morphology of the generated flower-ball-shaped cuprous oxide. It is found by the research of the disclosure that the mass ratio of the cuprous oxide nanoparticles to the Bacillus bacterial liquid is preferably controlled at (3-5): 1.

Further, the adding amount of the silane coupling agent in step (4) is 0.5%-2% of the total mass of the mixture obtained in step (3).

Since cuprous oxide is easy to hydrolyze in seawater, the phenomenon of “burst corrosion” is easy to appear, such that the fouling resistance fails and is shortened. The titanium-silicon film of the disclosure refers to titanium dioxide and silicon dioxide. By adding the titanium-silicon film on the surface of the cuprous oxide nanoparticles, the number of hydroxyl groups can be increased, so that the silane coupling agent is better grafted on the surface of the cuprous oxide nanoparticles, and the rate of cuprous ions released by cuprous oxide hydrolysis can also be delayed, so as to achieve the slow-release effect of the ions and prolong the fouling-resistant life of the coating. Meanwhile, titanium dioxide can effectively reflect and scatter ultraviolet rays, such that the coating layer has excellent insolation-resistant property.

A surface-grafted flower-ball-shaped nano cuprous oxide coated with a titanium-silicon film obtained by the preparation method.

Use of the surface-grafted flower-ball-shaped nano cuprous oxide coated with a titanium-silicon film in corrosion resistance, fouling resistance, insolation resistance, and erosion resistance.

A multifunctional water-based coating consists of the following raw materials in percentage by weight: 8-10% of the surface-grafted flower-ball-shaped nano cuprous oxide coated with a titanium-silicon film, 15-20% of nano lithium silicate, 60-70% of a water-based acrylic emulsion, 3-8% of a wetting agent, 3-5% of a defoaming agent and 2-5% of a dispersing agent.

Further, the defoaming agent is polydimethylsiloxane; the dispersing agent is one or more of sodium polyacrylate, carboxymethyl cellulose and hydroxyethyl cellulose; and the wetting agent is polyoxyethylene alkyl ether or polyoxyethylene octylphenol ether.

A method for preparing the multifunctional water-based coating includes the following steps:
(1) adding the surface-grafted flower-ball-shaped nano cuprous oxide coated with a titanium-silicon film, the water-based acrylic emulsion, the nano lithium silicate and the dispersing agent into a ball-milling tank at room temperature for ball milling for 24-48 h, wherein preferably, the volume is less than or equal to ⅓ of the ball-milling tank, then adding equal mass of zirconia mill balls, and ball-milling for 24 h at a speed of 130 rpm; and
(2) filtering the ball-milled slurry by a 100-mesh filter screen under a normal pressure to remove the zirconia mill balls; and dropwise adding the defoaming agent and the wetting agent into the filtrate, heating the filtrate to 55-65° C. in a water bath, and then transferring the filtrate into a vacuum defoaming machine for removing foams, wherein preferably, the foam removing is performed in the vacuum defoaming machine for 10 min while stirring is performed at a speed of 500 rpm.

Use of the multifunctional water-based coating in surface protection of coastal buildings, steel structures, ships, submarine oil and gas conveying pipelines and sea-crossing bridges.

Compared with the prior art, the disclosure has the following advantages:
(1) Cuprous oxide is reduced from a copper ion solution, and then a bacterial liquid is introduced to etch a flower-ball-shaped nano cuprous oxide, so as to significantly increase the surface area of the cuprous oxide. Besides, a silane coupling agent is used for surface modification of the flower-ball-shaped nano cuprous oxide, and other components such as acrylic resin are added to increase the dispersibility and the bonding strength of the cuprous oxide and organic components in the coating, so as to improve the strength of the coating layer and the performances such as ageing resistance and insolation resistance, and maintain the high fouling-resistant performance of the coating layer at the same time.
(2) The hardness, the wear resistance and the adhesion force with a matrix of the coating layer can be effectively improved by adding a small amount of nano lithium silicate powder in the disclosure.
(3) The multifunctional water-based coating containing a flower-ball-shaped nano cuprous oxide of the disclosure has multiple functions of resisting fouling, resisting corrosion, etc., has a wide application range, can be used on the surfaces of facilities such as steel structures, ships, submarine oil and gas conveying pipelines and cross-sea bridges, has a long service life, and can meet a long-term use requirement of more than one year.
(4) The materials used in the preparation method of the disclosure are cheap and easy to obtain, and water-based solvents used have no pollution to the environment, such that the coating is suitable for large-scale production.

### BRIEF DESCRIPTION OF THE DRAWINGS

FIG. 1 is a scanning electron microscope image of the surface-grafted flower-ball-shaped nano cuprous oxide coated with a titanium-silicon film of example 1;

FIG. 2 is a transmission electron microscope image of the surface-grafted flower-ball-shaped nano cuprous oxide coated with a titanium-silicon film of example 1;

FIG. 3 is an atomic force microscope image of the surface of the multifunctional water-based coating of example 1;

FIG. 4 is a water droplet contact angle of the multifunctional water-based coating of example 1;

FIG. 5 is a water droplet contact angle of the multifunctional water-based coating of comparative example 1;

FIG. 6 shows comparison of the surfaces of concrete hanging panels coated with the multifunctional water-based coatings of example 1 and comparative example 1 after 1 year;

FIG. 7 is an XPS plot of the flower-ball-shaped cuprous oxide coated with a titanium-silicon film of example 1;

FIG. 8 (a) is a scanning electron microscope image of the surface of the multifunctional water-based coating of comparative example 2;

FIG. 8 (b) is a scanning electron microscope image of the surface of the multifunctional water-based coating of example 1.

### DETAILED DESCRIPTION OF THE EMBODIMENTS

In order to make the objectives, technical solutions and advantages of the disclosure clearer, the disclosure will be further described in detail below with reference to the accompanying drawings.

### Example 1

A multifunctional water-based coating consists of the following raw materials in percentage by weight: 8% of surface-grafted flower-ball-shaped nano cuprous oxide coated with a titanium-silicon film, 15% of nano lithium silicate, 69% of a water-based acrylic emulsion, 3% of polyoxyethylene alkyl ether as a wetting agent, 3% of polydimethylsiloxane as a defoaming agent and 2% of sodium polyacrylate as a dispersing agent.

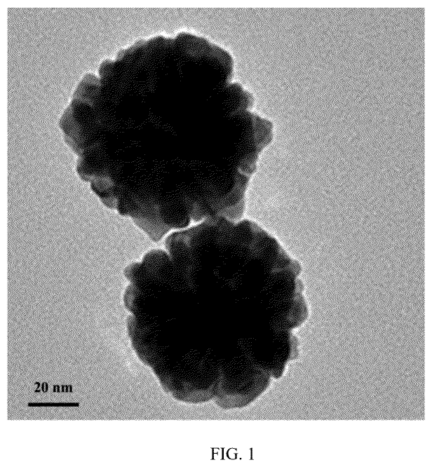

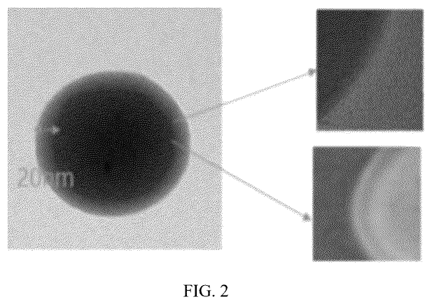

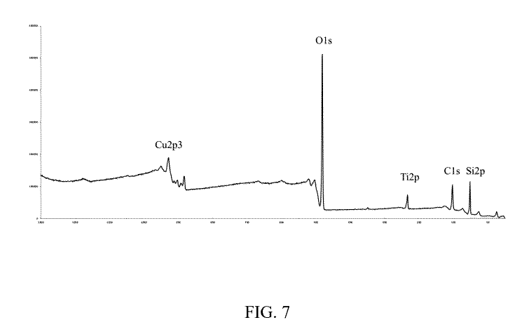

A method for preparing a surface-grafted flower-ball-shaped nano cuprous oxide coated with a titanium-silicon film was as follows:
1) an aqueous solution containing 0.01 mol/L of copper chloride was subjected to high-speed magnetic stirring (500 rpm) in a water bath at 50° C. and then 0.04 mol/L of a sodium hydroxide solution was slowly added, wherein the molar ratio of copper ions to hydroxide ions in the mixed solution obtained was 1:40;
2) 0.02 mol/L of ascorbic acid was added into the mixed solution in step 1), the mixed solution was continuously stirred for reaction at the reaction temperature of 50° C. for 30 min, then the reaction product was centrifuged and washed, and a precipitate was collected;
3) the precipitate collected in step 2) was dried to obtain cuprous oxide nanoparticles; the cuprous oxide nanoparticles were transferred into a tryptic soy broth (TSB), a Bacillus bacterial liquid was added, and the bacteria were cultured for 48 h in an orbital rotary shaker at 25° C. and 200 rpm, wherein preferably, components of the tryptic soy broth were: 17.0 g of trypticase, 3.0 g of soybean papain hydrolysate, 5.0 g of sodium chloride, 2.5 g of dextrose monohydrate, 2.5 g of dipotassium hydrogen phosphate and 1,000 ml of purified water, and the mass ratio of the cuprous oxide nanoparticles to the Bacillus bacterial liquid was 3:1;
4) after the culture was finished, the reaction mixture was centrifuged at 2,000 rpm for 5 min to remove the remaining components from the medium; and then the reaction mixture was centrifuged at 16,000 rpm for 10 min, the precipitate was washed, collected and dried to obtain flower-ball-shaped nano cuprous oxide, wherein a scanning electron microscope image was shown in FIG. 1; and the nano cuprous oxide was in a flower ball shape, had the diameter of about 100 nm, and had larger surface roughness and specific surface area;
5) the flower-ball-shaped nano cuprous oxide, tetraethyl titanate and tetraethyl orthosilicate were mixed at a mass ratio of 3:2:5, and a titanium-silicon film was formed on the surface of the flower-ball-shaped nano cuprous oxide, wherein the stirring was performed at a speed of 600 rpm for 10 min; and
6) the flower-ball-shaped nano cuprous oxide particle with a titanium-silicon film in step 5) was mixed with absolute ethanol at a mass ratio of 1:5 and 10 wt % of glacial acetic acid was added to adjust the pH value of the solution to 5; and then 10% by mass of a silane coupling agent KH570 was added and the mixture was stirred for 2 h in a water bath at 50° C. at a speed of 300 rpm to obtain surface-grafted flower-ball-shaped nano cuprous oxide particles coated with a titanium-silicon film. An XPS plot of the flower-ball-shaped cuprous oxide coated with a titanium-silicon film was shown in FIG. 7. It can be seen that titanium and silicon were successfully coated on the surface of cuprous oxide. A transmission electron microscope image of the surface-grafted flower-ball-shaped nano cuprous oxide particle coated with a titanium-silicon film was shown in FIG. 2. It can be seen that the surface of the cuprous oxide was coated with two layers: the titanium-silicon film and the silane coupling agent.

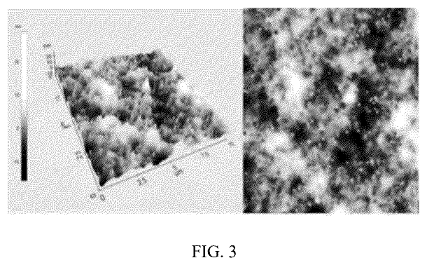

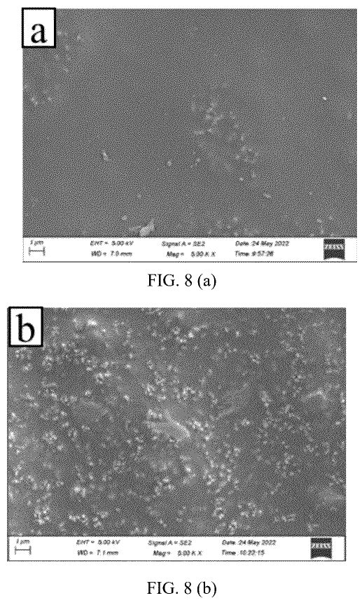

A method for preparing the multifunctional water-based coating included the following steps:
S1, the surface-grafted flower-ball-shaped nano cuprous oxide coated with a titanium-silicon film, the water-based acrylic emulsion, the nano lithium silicate and the dispersing agent were added into a ball-milling tank at room temperature, wherein the volume was less than or equal to ⅓ of the ball-milling tank, then an equal mass of zirconia mill balls was added, and the ball milling was performed for 24 h at a speed of 130 rpm; and
S2, the ball-milled slurry was filtered by a 100-mesh filter screen under a normal pressure to remove the zirconia mill balls; and the defoaming agent and the wetting agent were dropwise added into the filtrate, then the filtrate was heated to 55° C. in a water bath, and then the filtrate was placed into a vacuum defoaming machine for removing foams for 10 min and meanwhile stirred at a speed of 500 rpm to obtain a multifunctional water-based coating. An atomic force microscope image and a scanning electron microscope image of the surface of the coating were respectively shown in FIG. 3 and FIG. 8 (b). The surface of the coating layer formed a lotus-leaf-like structure and had certain hydrophobic ability.

### Example 2

A multifunctional water-based coating consists of the following raw materials in percentage by weight: 10% of a surface-grafted flower-ball-shaped nano cuprous oxide coated with a titanium-silicon film, 20% of nano lithium silicate, 60% of a water-based acrylic emulsion, 5% of polyoxyethylene alkyl ether as a wetting agent, 3% of polydimethylsiloxane as a defoaming agent and 2% of carboxymethyl cellulose as a dispersing agent.

Wherein a method for preparing a surface-grafted flower-ball-shaped nano cuprous oxide coated with a titanium-silicon film was as follows:
1) an aqueous solution containing 0.01 mol/L of copper chloride was subjected to high-speed magnetic stirring (500 rpm) in a water bath at 50° C. and then 0.04 mol/L of a sodium hydroxide solution was slowly added, wherein the molar ratio of copper ions to hydroxide ions in the mixed solution obtained was 1:40;
2) 0.02 mol/L of ascorbic acid was added into the mixed solution in step 1), the mixed solution was continuously stirred for reaction at a reaction temperature of 50° C. for 30 min, then the reaction product was centrifuged and washed, and a precipitate was collected;
3) the precipitate collected in step 2) was dried to obtain cuprous oxide nanoparticles; the cuprous oxide nanoparticles were transferred into a tryptic soy broth (TSB), a Bacillus bacterial liquid was added, and the bacteria were cultured for 48 h in an orbital rotary shaker at 25° C. and 200 rpm, wherein the mass ratio of the cuprous oxide nanoparticles to the Bacillus bacterial liquid was 5:1;
4) after the culture was finished, the reaction mixture was centrifuged at 2,000 rpm for 5 min to remove the remaining components from the medium; and then the reaction mixture was centrifuged at 16,000 rpm for 10 min, and the precipitate was washed, collected and dried to obtain flower-ball-shaped nano cuprous oxide;
5) the flower-ball-shaped nano cuprous oxide, tetraethyl titanate and tetraethyl orthosilicate were mixed at a mass ratio of 3:2:5, and a titanium-silicon film was formed on the surface of the flower-ball-shaped nano cuprous oxide, wherein the stirring was performed at a speed of 700 rpm for 10 min; and
6) the flower-ball-shaped nano cuprous oxide particle with a titanium-silicon film in step 5) was mixed with absolute ethanol at a mass ratio of 1:5 and 10 wt % of glacial acetic acid was added to adjust the pH value of the solution to 5; and then 10% by mass of a silane coupling agent KH570 was added and the mixture was stirred for 2 h in a water bath at 50° C. at a speed of 400 rpm to obtain surface-grafted flower-ball-shaped nano cuprous oxide particles coated with a titanium-silicon film.

A method for preparing the multifunctional water-based coating was as follows:
S1, the surface-grafted flower-ball-shaped nano cuprous oxide coated with a titanium-silicon film, the water-based acrylic emulsion, the nano lithium silicate and the dispersing agent were added into a ball-milling tank at room temperature, wherein the volume was less than or equal to ⅓ of the ball-milling tank, then an equal mass of zirconia mill balls were added, and the ball milling was performed for 24 h at a speed of 130 rpm; and
S2, the ball-milled slurry was filtered by a 100-mesh filter screen under a normal pressure to remove the zirconia mill balls; and the defoaming agent and the wetting agent were dropwise added into the filtrate, then the filtrate was heated to 55° C. in a water bath, and then the filtrate was placed into a vacuum defoaming machine for removing foams for 10 min and meanwhile stirred at a speed of 500 rpm to obtain a multifunctional water-based coating.

### Example 3

A multifunctional water-based coating consists of the following raw materials in percentage by weight: 9% of a surface-grafted flower-ball-shaped nano cuprous oxide coated with a titanium-silicon film, 17% of nano lithium silicate, 65% of a water-based acrylic emulsion, 4% of polyoxyethylene octylphenol ether as a wetting agent, 3% of polydimethylsiloxane as a defoaming agent and 2% of hydroxyethyl cellulose as a dispersing agent.

A method for preparing a surface-grafted flower-ball-shaped nano cuprous oxide coated with a titanium-silicon film was as follows:
1) an aqueous solution containing 0.01 mol/L of copper acetate was subjected to high-speed magnetic stirring (500 rpm) in a water bath at 30° C. and then 0.03 mol/L of an ammonia water solution was slowly added, wherein the molar ratio of copper ions to hydroxide ions in the mixed solution obtained was 1:40;
2) 0.01 mol/L of glucose was added into the mixed solution in step 1), the mixed solution was continuously stirred for reaction at the reaction temperature of 25° C. for 30 min, then the reaction product was centrifuged and washed, and a precipitate was collected;
3) the precipitate collected in step 2) was dried to obtain cuprous oxide nanoparticles; the cuprous oxide nanoparticles were transferred into a tryptic soy broth (TSB), a Bacillus bacterial liquid was added, and the bacteria were cultured for 48 h in an orbital rotary shaker at 25° C. and 200 rpm, wherein the mass ratio of the cuprous oxide nanoparticles to the Bacillus bacterial liquid was 4:1;
4) after the culture was finished, the reaction mixture was centrifuged at 2,000 rpm for 5 min to remove the remaining components from the medium; and then the reaction mixture was centrifuged at 16,000 rpm for 10 min, and the precipitate was washed, collected and dried to obtain flower-ball-shaped nano cuprous oxide;
5) the flower-ball-shaped nano cuprous oxide, tetraethyl titanate and tetraethyl orthosilicate were mixed at a mass ratio of 3:2:5, and a titanium-silicon film was formed on the surface of the flower-ball-shaped nano cuprous oxide, wherein the stirring was performed at a speed of 800 rpm for 10 min; and
6) the flower-ball-shaped nano cuprous oxide particle with a titanium-silicon film in step 5) was mixed with absolute ethanol at a mass ratio of 1:5 and 10 wt % of glacial acetic acid was added to adjust the pH value of the solution to 5; and then 10% by mass of a silane coupling agent KH570 was added and the mixture was stirred for 2 h in a water bath at 50° C. at a speed of 500 rpm to obtain surface-grafted flower-ball-shaped nano cuprous oxide particles coated with a titanium-silicon film.

A method for preparing the multifunctional water-based coating was as follows:
S1, the surface-grafted flower-ball-shaped nano cuprous oxide coated with a titanium-silicon film, the water-based acrylic emulsion, the nano lithium silicate and the dispersing agent were added into a ball-milling tank at room temperature, wherein the volume was less than or equal to ⅓ of the ball-milling tank, then an equal mass of zirconia mill balls were added, and the ball milling was performed for 24 h at a speed of 130 rpm; and
S2, the ball-milled slurry was filtered by a 100-mesh filter screen under a normal pressure to remove the zirconia mill balls; and the defoaming agent and the wetting agent were dropwise added into the filtrate, then the filtrate was heated to 55° C. in a water bath, and then the filtrate was placed into a vacuum defoaming machine for removing foams for 10 min and meanwhile stirred at a speed of 500 rpm to obtain a multifunctional water-based coating.

### Example 4

A multifunctional water-based coating consists of the following raw materials in percentage by weight: 10% of a surface-grafted flower-ball-shaped nano cuprous oxide coated with a titanium-silicon film, 17% of nano lithium silicate, 66% of a water-based acrylic emulsion, 3% of polyoxyethylene octylphenol ether as a wetting agent, 2% of polydimethylsiloxane as a defoaming agent and 2% of hydroxyethyl cellulose as a dispersing agent.

A method for preparing a surface-grafted flower-ball-shaped nano cuprous oxide coated with a titanium-silicon film was as follows:
1) an aqueous solution containing 0.01 mol/L of copper acetate was subjected to high-speed magnetic stirring (500 rpm) in a water bath at 30° C. and 0.03 mol/L of an ammonium hydroxide solution was slowly added, wherein the molar ratio of copper ions to hydroxide ions in the mixed solution obtained was 1:40;
2) 0.01 mol/L of glucose was added into the mixed solution in step 1), the mixed solution was continuously stirred for reaction at the reaction temperature of 25° C. for 30 min, then the reaction product was centrifuged and washed, and a precipitate was collected;
3) the precipitate collected in step 2) was dried to obtain cuprous oxide nanoparticles; the cuprous oxide nanoparticle was transferred into a tryptic soy broth (TSB), a Bacillus bacterial liquid was added, and the bacteria were cultured for 48 h in an orbital rotary shaker at 25° C. and 200 rpm, wherein the mass ratio of the cuprous oxide nanoparticles to the Bacillus bacterial liquid was 4:1;
4) after the culture was finished, the reaction mixture was centrifuged at 2,000 rpm for 5 min to remove the remaining components from the medium; and then the reaction mixture was centrifuged at 16,000 rpm for 10 min, and the precipitate was washed, collected and dried to obtain flower-ball-shaped nano cuprous oxide;
5) the flower-ball-shaped nano cuprous oxide, tetraethyl titanate and tetraethyl orthosilicate were mixed at a mass ratio of 3:2:5, and a titanium-silicon film was formed on the surface of the flower-ball-shaped nano cuprous oxide, wherein the stirring was performed at a speed of 800 rpm for 10 min; and
6) the flower-ball-shaped nano cuprous oxide particle with a titanium-silicon film in step 5) was mixed with absolute ethanol at a mass ratio of 1:5 and 10 wt % of glacial acetic acid was added to adjust the pH value of the solution to 5; and then 10% by mass of a silane coupling agent KH570 was added and the mixture was stirred for 2 h in a water bath at 50° C. at a speed of 500 rpm to obtain a surface-grafted flower-ball-shaped nano cuprous oxide particle coated with a titanium-silicon film.

A method for preparing the multifunctional water-based coating was as follows:
S1, the surface-grafted flower-ball-shaped nano cuprous oxide coated with a titanium-silicon film, the water-based acrylic emulsion, the nano lithium silicate and the dispersing agent were added into a ball-milling tank at room temperature, wherein the volume was less than or equal to ⅓ of the ball-milling tank, then an equal mass of zirconia mill balls were added, and the ball milling was performed for 24 h at a speed of 130 rpm; and
S2, the ball-milled slurry was filtered by a 100-mesh filter screen under a normal pressure to remove the zirconia mill balls; and the defoaming agent and the wetting agent were dropwise added into the filtrate, then the filtrate was heated to 55° C. in a water bath, and then the filtrate was placed into a vacuum defoaming machine for removing foams for 10 min and meanwhile stirred at a speed of 500 rpm to obtain a multifunctional water-based coating.

### Comparative Example 1

A multifunctional water-based coating and a preparation method therefor provided by the present comparative example were approximately the same as those of example 1. The main difference was as follows: the surface-grafted flower-ball-shaped nano cuprous oxide coated with a titanium-silicon film in example 1 was replaced with a common nano cuprous oxide particle in comparative example 1.

### Comparative Example 2

A multifunctional water-based coating and a preparation method therefor provided by the present comparative example were approximately the same as those of example 1. The main difference was as follows: the surface-grafted flower-ball-shaped nano cuprous oxide coated with a titanium-silicon film in example 1 was replaced with flower-ball-shaped nano cuprous oxide not modified by a silane coupling agent and not coated with a titanium-silicon film in comparative example 2. A scanning electron microscope image of the coating obtained in comparative example 2 was shown in FIG. 8 (a). The coating had relatively poor hydrophobicity.

### Comparative Example 3

A multifunctional water-based coating and a preparation method therefor provided by the present comparative example were approximately the same as those of example 1. The main difference was as follows: nano lithium silicate was not added in comparative example 3.

### Comparative Example 4

A multifunctional water-based coating and a preparation method therefor provided by the present comparative example were approximately the same as those of example 1. The main difference was as follows: the surface-grafted flower-ball-shaped nano cuprous oxide coated with a titanium-silicon film in example 1 was replaced with common nano cuprous oxide particles (not containing a titanium-silicon film) modified with the silane coupling agent KH570 in comparative example 4.

### Comparative Example 5

A multifunctional water-based coating and a preparation method therefor provided by the present comparative example were approximately the same as those of example 1. The main difference was as follows: the Bacillus bacterial liquid in example 1 was replaced with a Gram bacteria liquid in comparative example 5. It was found that since the Gram bacteria had too strong corrosion ability, the specific surface area of the cuprous oxide obtained was too large. The surface could not be completely covered by the titanium-silicon film during modification. The performances of the finally obtained coating were not satisfactory.

### Comparative Example 6

A multifunctional water-based coating and a preparation method therefor provided by the present comparative example were approximately the same as those of example 1. The main difference was as follows: “step 5) the flower-ball-shaped nano cuprous oxide, tetraethyl titanate and tetraethyl orthosilicate were mixed at a mass ratio of 3:2:5, and a titanium-silicon film was formed on the surface of the flower-ball-shaped nano cuprous oxide, wherein the stirring was performed at a speed of 800 rpm for 10 min” in example 1 was not contained in comparative example 6. Namely, a coupling agent was directly added on the surface of the flower-ball-shaped cuprous oxide for modification. But the modification was unsuccessful. Since the surface of the cuprous oxide has no hydroxyl group or few hydroxyl groups, the cuprous oxide could not be connected with the silane coupling agent.

### Performance Test

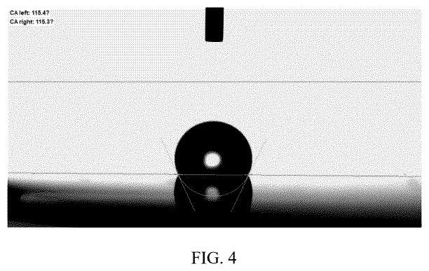

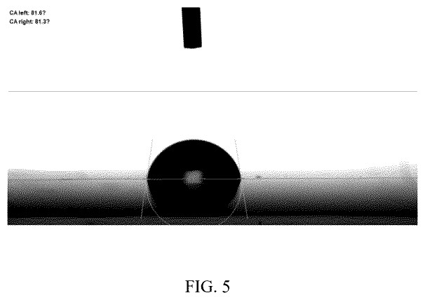

The surface of a Q235 steel panel was subjected to sand blasting to achieve smoothness of Sa 2.5 and then the steel panel was thoroughly cleaned by acetone to remove grease and other pollutants. Subsequently, the multifunctional water-based coatings of examples 1-4 and comparative examples 1-4 with a thickness of 80 μm were respectively sprayed on the Q235 steel panel (1,000*500*50 mm) using an air spraying method under 0.5 MPa and at room temperature. The coated steel panels were air-dried at room temperature for 5 days to obtain coating layer samples. The coating layers of the 8 hanging panels were subjected to performance tests such as wear resistance and erosion resistance. The test results were shown in Tables 1-2 and FIGS. 4-5 below.

TABLE 1
Comparison of performances of coating layers
obtained in examples and comparative examples

| | Water | | Erosion | |
|---|---|---|---|---|
| | droplet | | resistance | |
| | contact | Adhesion | (coating | Salt spray |
| Performances | angle | force | layer mass | resistance |
| No. | (degree) | (grade) | loss, g) | (h) |
| Test standards | GB/T 6541 | GB/T 5210 | GB/T 1732 | GB/T 1771 |
| Example 1 | 115.4 | 1 | 35 | 1900 |
| Example 2 | 113.1 | 1 | 32 | 1900 |
| Example 3 | 112.6 | 1 | 38 | 2000 |
| Example 4 | 112.3 | 1 | 33 | 2000 |
| Comparative | 81.6 | 1 | 127 | 850 |
| example 1 | | | | |
| Comparative | 85.5 | 1 | 113 | 1300 |
| example 2 | | | | |
| Comparative | 100.2 | 1 | 155 | 1500 |
| example 3 | | | | |
| Comparative | 88.7 | 1 | 111 | 1200 |
| example 4 | | | | |

It could be seen from table 1 that the coating prepared from the cuprous oxide not modified by the silane coupling agent had weak adhesion force with water-based resin and poor hydrophobicity. The coating of comparative example 1 prepared from the common cuprous oxide particle had the worst performances. The coating of comparative example 3 did not contain lithium sulfate and therefore had the worst erosion resistance. The common cuprous oxide modified by the silane coupling agent was added in the coating of comparative example 4. The performances of the coating were all inferior to those of the coatings of the disclosure, but slightly better than those of comparative example 1.

After the 8 hanging panels were soaked in seawater for 1 year, it was found that the coating enhanced by the surface-grafted modified flower-ball-shaped nano cuprous oxide with a titanium-silicon film had very good surface quality and fouling-resistant performance.

TABLE 2
Comparison of fouling-resistant performances of coating
layers obtained in examples and comparative examples.

| | Test | Appearance | Number of |
|---|---|---|---|
| Performances | duration | of coating | barnacles on |
| No. | (month) | layer | surface |
| Test standards | Timing | Visual inspection | Visual inspection |
| Example 1 | 12 | Complete | Few |
| Example 2 | 12 | Complete | Few |
| Example 3 | 12 | Complete | Few |
| Example 4 | 12 | Complete | Few |
| Comparative | 12 | Severe erosion | More |
| example 1 | | | |
| Comparative | 12 | Severe erosion | Many |
| example 2 | | | |
| Comparative | 12 | Severe erosion | Many |
| example 3 | | | |
| Comparative | 12 | Relatively severe | Relatively many |
| example 4 | | erosion | |

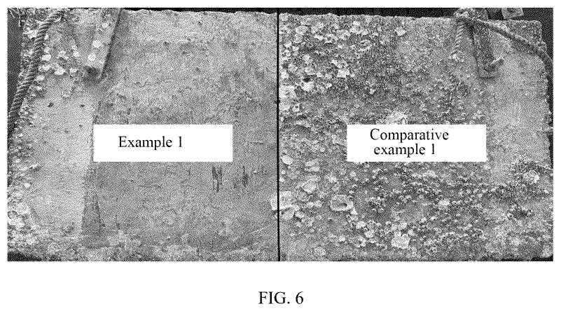

Comparison of the surfaces of concrete hanging panels coated with the multifunctional water-based coatings of example 1 and comparative example 1 after 1 year was shown in FIG. 6. It could be found that the multifunctional water-based coating of the disclosure had stronger strength of the coating layer, erosion resistance and ageing resistance. The coating layer could maintain the lasting stability for more than one year.

It could be obtained from the analysis that cuprous oxide was reduced from a copper ion solution of the disclosure and then a bacterial liquid was introduced to etch a flower-ball-shaped nano cuprous oxide, so as to improve the dispersibility and the bonding strength of the flower-ball-shaped nano cuprous oxide in the coating through surface modification. Secondly, the flower-ball-shaped nano cuprous oxide with a surface-grafted titanium-silicon film was subjected to surface modification by using a silane coupling agent, so as to improve the strength of the coating layer and the performances such as ageing resistance and insolation resistance, and significantly improve the fouling-resistant performance of the coating layer. The hardness, the wear resistance and the adhesion force with a matrix of the coating layer could be effectively improved by adding a small amount of nano lithium silicate powder in the coating.

The above examples are only intended to describe the specific embodiments of the disclosure, and not to limit the scope of the disclosure, and those skilled in the art can make various modifications and changes based on the prior art. Various changes and modifications made to the technical solution of the disclosure by those skilled in the art should fall within the protection defined by the claims of the disclosure without departing from the spirit of the disclosure.

What is claimed is:

1. A method for preparing a surface-grafted flower-ball-shaped nano cuprous oxide coated with a titanium-silicon film, comprising the following steps:
a) preparing a flower-ball-shaped nano cuprous oxide: transferring cuprous oxide nanoparticles into a tryptic soy broth, adding a Bacillus bacterial liquid, and culturing for 48-72 h in an orbital rotary shaker at 25-30° C.; and after the culture is finished, centrifuging and washing the reaction mixture, and collecting and drying a precipitate to obtain flower-ball-shaped nano cuprous oxide;
b) stirring and mixing the flower-ball-shaped nano cuprous oxide, tetraethyl titanate and tetraethyl orthosilicate at a mass ratio of (3-5):(2-4):(5-10), and forming a titanium-silicon film on the surface of the flower-ball-shaped nano cuprous oxide;
c) mixing the flower-ball-shaped nano cuprous oxide particles with a titanium-silicon film obtained in step (b) with absolute ethanol at a mass ratio of (1-3):5; and
d) then adjusting the pH value to 5, adding a silane coupling agent, and stirring in a water bath at 50-60° C. for 2-4 h to obtain the surface-grafted flower-ball-shaped nano cuprous oxide coated with a titanium-silicon film.

2. The preparation method of claim 1, wherein the mass ratio of the cuprous oxide nanoparticles to the Bacillus bacterial liquid is (3-5): 1.

3. The preparation method of claim 1, wherein the adding amount of the silane coupling agent in step d) is 0.5%-2% of the total mass of the mixture obtained in step c).

4. A surface-grafted flower-ball-shaped nano cuprous oxide coated with a titanium-silicon film obtained by the preparation method of claim 1.

5. Use of the surface-grafted flower-ball-shaped nano cuprous oxide coated with a titanium-silicon film of claim 4 in corrosion resistance, fouling resistance, insolation resistance, and erosion resistance.

6. A multifunctional water-based coating, wherein the coating consists of the following raw materials in percentage by weight: 8-10% of the surface-grafted flower-ball-shaped nano cuprous oxide coated with a titanium-silicon film of claim 4, 15-20% of nano lithium silicate, 60-69% of a water-based acrylic emulsion, 3-8% of a wetting agent, 3-5% of a defoaming agent and 2-5% of a dispersing agent.

7. The multifunctional water-based coating of claim 6, wherein the defoaming agent is polydimethylsiloxane; the dispersing agent is one or more of sodium polyacrylate, carboxymethyl cellulose and hydroxyethyl cellulose, and the wetting agent is polyoxyethylene alkyl ether or polyoxyethylene octylphenol ether.

8. A method for preparing the multifunctional water-based coating of claim 6, comprising the following steps:
a) adding the surface-grafted flower-ball-shaped nano cuprous oxide coated with a titanium-silicon film, the water-based acrylic emulsion, the nano lithium silicate and the dispersing agent into a ball-milling tank at room temperature for ball milling for 24-48 h; and
b) filtering the ball-milled slurry by a 100-mesh filter screen under a normal pressure to remove zirconia mill balls; and dropwise adding the defoaming agent and the wetting agent into the filtrate, heating the filtrate to 55-65° C. in a water bath, and then placing the filtrate into a vacuum defoaming machine for removing foams.

9. Use of the multifunctional water-based coating of claim 6 in surface protection of coastal buildings, steel structures, ships, submarine oil and gas conveying pipelines and sea-crossing bridges.
